(19) United States
(12) Patent Application Publication
(10) Pub. No.: US 2017/0307362 A1
(43) Pub. Date: Oct. 26, 2017

(54) SYSTEM AND METHOD FOR ENVIRONMENT RECOGNITION

(71) Applicant: Caterpillar Inc., Peoria, IL (US)

(72) Inventors: Nicolas François-Xavier Christophe Vandapel, Pittsburgh, PA (US); Michael Karl Wilhelm Happold, Pittsburgh, PA (US); Nicholas Chan, Pittsburgh, PA (US)

(73) Assignee: Caterpillar Inc., Peoria, IL (US)

(21) Appl. No.: 15/136,305

(22) Filed: Apr. 22, 2016

(51) Int. Cl. G01B 11/24

(52) U.S. Cl. CPC G01B 11/2433

(57) ABSTRACT

An environment recognition system for a machine operating at a worksite is provided. A processing device of the environment recognition system receives a plurality of data points from at least one perception sensor. The processing device generates an environment map and detects a plurality of objects. Further, the processing device extracts a geometry and computes an expected shadow of each of the plurality of detected objects. The processing device detects one or more missing data points indicative of a casted shadow of the respective detected object. The processing device computes a geometry of the casted shadow and compares the casted shadow with the expected shadow of the respective detected object. The processing device determines whether the geometry of any of the plurality of detected objects has been misestimated based on the comparison of the casted shadow with the expected shadow of the respective detected object.

### TECHNICAL FIELD

The present disclosure relates to an environment recognition system. More particularly, the present disclosure relates to the environment recognition system associated with a machine operating at a worksite.

### BACKGROUND

Movable machines such as rotary drills, haul trucks, dozers, motor graders, excavators, wheel loaders, and other types of equipment are used to perform a variety of tasks. For example, these machines may be used to move material and/or alter work surfaces at a work site. The machines may perform operations such as drilling, digging, loosening, carrying, etc., different materials at the worksite.

Some of the machines such as autonomous blast holes drills may need to be able to navigate efficiently on benches. To achieve such capabilities a map of an environment may be built based on inputs from a perception system. However, the perception system may have a limited vantage point of the environment so the map may contains areas having missing data due to occlusions, poor data density and accuracy at range. Furthermore, sensors associated with the perception system may have limited and discrete resolution. Due to limited sensor range, object sizes within the map may be underestimated. The objects having less reflective surfaces, such as flat black planes, may also produce gaps in the data. Further, due to such missing data path planning algorithms, motion prediction of moving objects, and the completeness of the environment model may be constrained.

U.S. Pat. No. 8,842,036 describes a method, a radar image registration manager, and a set of instructions. A primary sensor interface receives a primary sensor image and a camera model of the primary sensor image. A data storage stores a digital elevation model. A processor automatically aligns the primary sensor image with the digital elevation model.

However, known systems using perception sensors to estimate the environment continue to contain missing data due to sensor limitations and object occlusion. Hence there is a need for an improved system for environment recognition.

### SUMMARY OF THE DISCLOSURE

In an aspect of the present disclosure, an environment recognition system for a machine operating at a worksite is provided. The environment recognition system includes at least one perception sensor associated with the machine. The at least one perception sensor is configured to output a plurality of data points corresponding to an environment around the machine. A processing device is communicably coupled to the at least one perception sensor. The processing device is configured to receive the plurality of data points from the at least one perception sensor. The processing device is configured to generate an environment map based on the received plurality of data points. The processing device is configured to detect a plurality of objects within the generated environment map. Further, the processing device is configured to extract a geometry of each of the plurality of detected objects. The processing device is configured to compute an expected shadow of each of the plurality of detected objects based on the extracted geometry. The processing device is configured to detect one or more missing data points in the generated environment map. The one or more missing data points are indicative of a casted shadow of the respective detected object. The processing device is configured to compute a geometry of the casted shadow of the respective detected object. The processing device is configured to compare the casted shadow with the expected shadow of the respective detected object. The processing device is configured to determine whether the geometry of any of the plurality of detected objects has been misestimated based on the comparison of the casted shadow with the expected shadow of the respective detected object.

In another aspect of the present disclosure, a method for environment recognition associated with a machine operating on a worksite is provided. The method includes receiving a plurality of one or more data points from at least one perception sensor. The method includes generating an environment map based on the received plurality of one or more data points. The method includes detecting a plurality of objects within the generated environment map. The method includes extracting a geometry of each of the plurality of detected objects. The method includes computing an expected shadow of each of the plurality of detected objects based on the extracted geometry. The method includes detecting one or more missing data points in the generated environment map. The one or more missing data points are indicative of a casted shadow of the respective detected object. The method includes computing a geometry of the casted shadow of the respective detected object. The method includes comparing the casted shadow with the expected shadow of the respective detected object. The method includes determining whether the geometry of any of the plurality of detected objects has been misestimated based on the comparison of the casted shadow with the expected shadow of the respective detected object.

In yet another aspect of the present disclosure, a computer program product is provided. The computer program product is embodied in a computer readable medium. The computer program product is useable with a programmable processing device for environment recognition at a worksite. The computer program product is configured to execute a set of instructions comprising receiving a plurality of one or more data points from at least one perception sensor. The computer program product is configured to execute a set of instructions comprising generating an environment map based on the received plurality of one or more data points. The computer program product is configured to execute a set of instructions comprising detecting a plurality of objects within the generated environment map. The computer program product is configured to execute a set of instructions comprising extracting a geometry of each of the plurality of detected objects. The computer program product is configured to execute a set of instructions comprising computing an expected shadow of each of the plurality of detected objects based on the extracted geometry. The computer program product is configured to execute a set of instructions comprising detecting one or more missing data points in the generated environment map. The one or more missing data points are indicative of a casted shadow of the respective detected object. The computer program product is configured to execute a set of instructions comprising computing a geometry of the casted shadow of the respective detected object. The computer program product is configured to execute a set of instructions comprising comparing the casted shadow with the expected shadow of the respective detected object. The computer program product is configured to execute a set of instructions comprising determining whether the geometry of any of the plurality of detected objects has been misestimated based on the comparison of the casted shadow with the expected shadow of the respective detected object.

Other features and aspects of this disclosure will be apparent from the following description and the accompanying drawings.

### BRIEF DESCRIPTION OF THE DRAWINGS

FIG. 1 is a schematic view of an exemplary work, according to one embodiment of the present disclosure;

FIG. 2 is a side view of a machine operating on the worksite, according to one embodiment of the present disclosure;

FIG. 3 is a schematic top plan view of the machine of FIG. 2, according to one embodiment of the present disclosure;

FIGS. 4 and 5 are schematic diagrams of an environment recognition system depicting intermediate outputs, according to one embodiment of the present disclosure;

FIG. 6 is a schematic of a low-level implementation of a computer-based system that can be configured to perform functions of the environment recognition system, according to one embodiment of the present disclosure; and

FIG. 7 is a flowchart of a method of operation of the environment recognition system, according to one embodiment of the present disclosure.

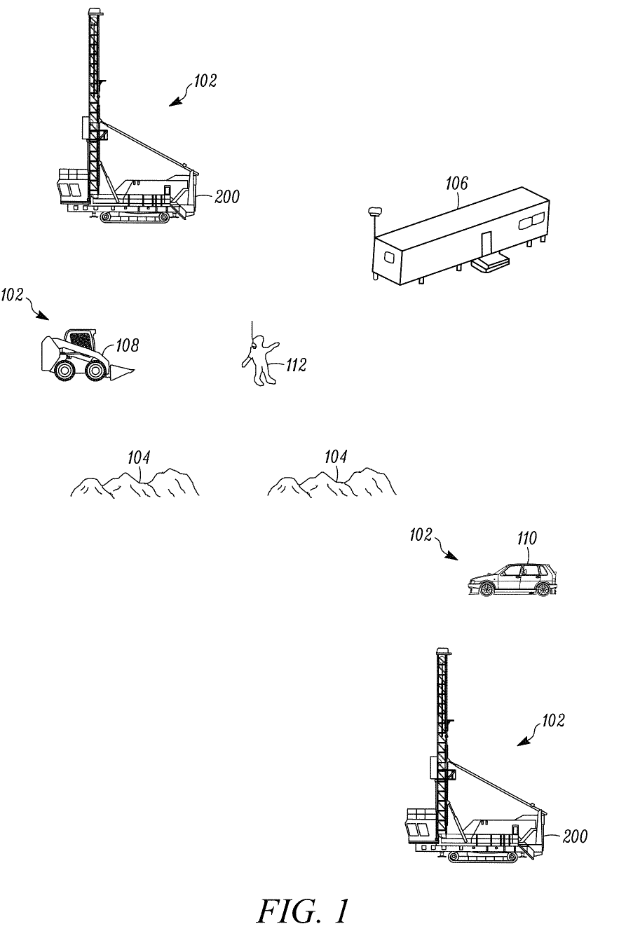

### DETAILED DESCRIPTION

Wherever possible, the same reference numbers will be used throughout the drawings to refer to the same or the like parts. FIG. 1 illustrates an exemplary worksite 100 with machines 102 operating at the worksite 100. The worksite 100 may include, for example, a mine site, a landfill, a quarry, a construction site, a road work site, or any other type of worksite. The machines 102 may perform any of a plurality of desired operations or tasks at the worksite 100, and such operations or tasks may require the machine 102 to generally traverse the worksite 100. Any number of the machines 102 may simultaneously and cooperatively operate at the worksite 100, as desired. As depicted in FIG. 1, two machines 102 are depicted as rotary drill machines. Alternatively, the machines 102 may embody any type of machine including dozers, excavators, haul trucks, and any other machine capable of moving about a worksite 100.

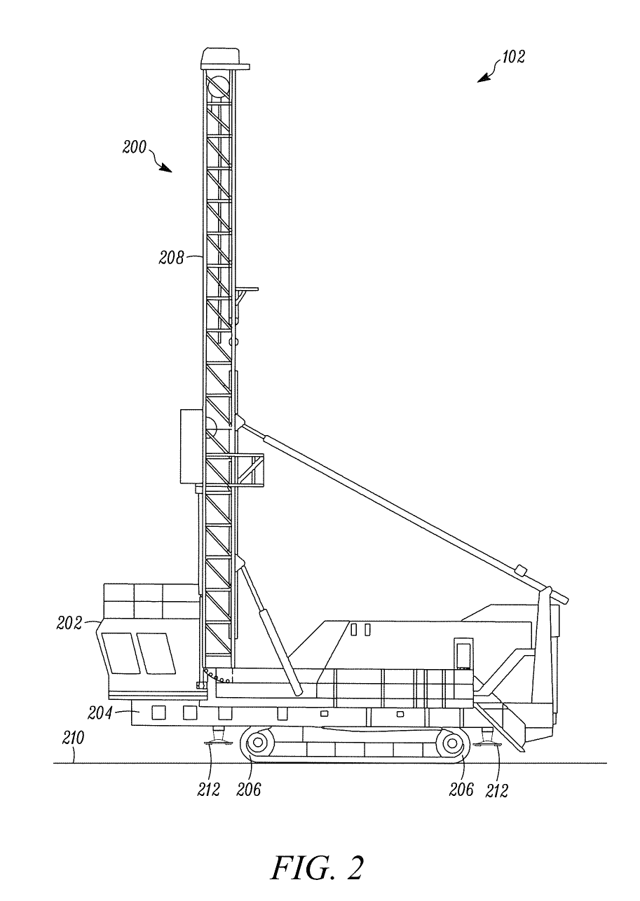

The machines 102 may be configured to be operated autonomously, semi-autonomously, or manually. When operating semi-autonomously or manually, the machines 102 may be operated by remote control and/or by an operator physically located within an operator station 202 (see FIG. 2) of the machine 102. As used herein, the machine 102 operating in an autonomous manner operates automatically based upon information received from various sensors without the need for human operator input. The machine 102 operating semi-autonomously includes an operator, either within the machine 102 or remotely, who performs some tasks or provides some input and other tasks are performed automatically and may be based upon information received from various sensors. The machine 102 being operated manually is one in which an operator is controlling all or essentially all of the functions of the machine 102. The machine 102 may be operated remotely by an operator (i.e., remote control) in either a manual or semiautonomous manner.

In addition to the machines 102 operating at worksite 100, various types of obstacles may be located at the worksite 100. The obstacles may embody any type of object including those that are fixed or stationary as well as those that are movable or that are moving. Examples of fixed obstacles may include mounds of material 104, infrastructure, storage, and processing facilities, buildings such as a command center 106, trees, and other structures and fixtures found at the worksite 100. Examples of movable obstacles include other machines such as a skid steer loader 108, a light duty vehicles 110, personnel 112, and other objects that may move about the worksite 100.

Referring to FIG. 2, an exemplary machine 102 is illustrated. A rotary drill machine 200 may include a frame 204 supported on a ground engaging drive mechanism such as tracks 206 that are operatively connected to a propulsion system (not shown) associated with the machine 102 for propelling the machine 102 about the worksite 100. The rotary drill machine 200 further includes a mast 208 pivotably mounted on the frame 204 and movable between a vertical drilling position, as depicted in FIG. 2, and a horizontal transport position (not shown). During a drilling operation, the rotary drill machine 200 may be raised above the work surface 210 and supported on jacks 212. The rotary drill machine 200 may include the cab or operator station 202 that an operator may physically occupy and provide input to operate the machine 102.

The machine 102 may include a control system (not shown). The control system may utilize one or more sensors to provide data and input signals representative of various operating parameters of the machine 102 and the environment of the worksite 100 at which the machine 102 is operating. The control system may include an electronic control module associated with the machine 102.

The machine 102 may be equipped with a plurality of machine sensors that provide data indicative (directly or indirectly) of various operating parameters of the machine and/or the operating environment in which the machine is operating. The term “sensor” is meant to be used in its broadest sense to include one or more sensors and related components that may be associated with the machine 102 and that may cooperate to sense various functions, operations, and operating characteristics of the machine and/or aspects of the environment in which the machine 102 is operating.

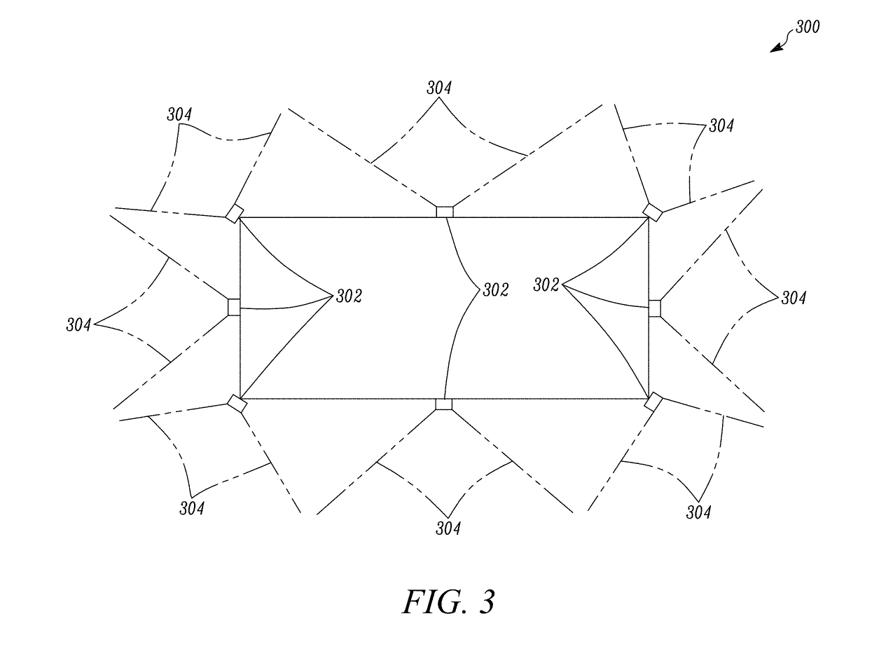

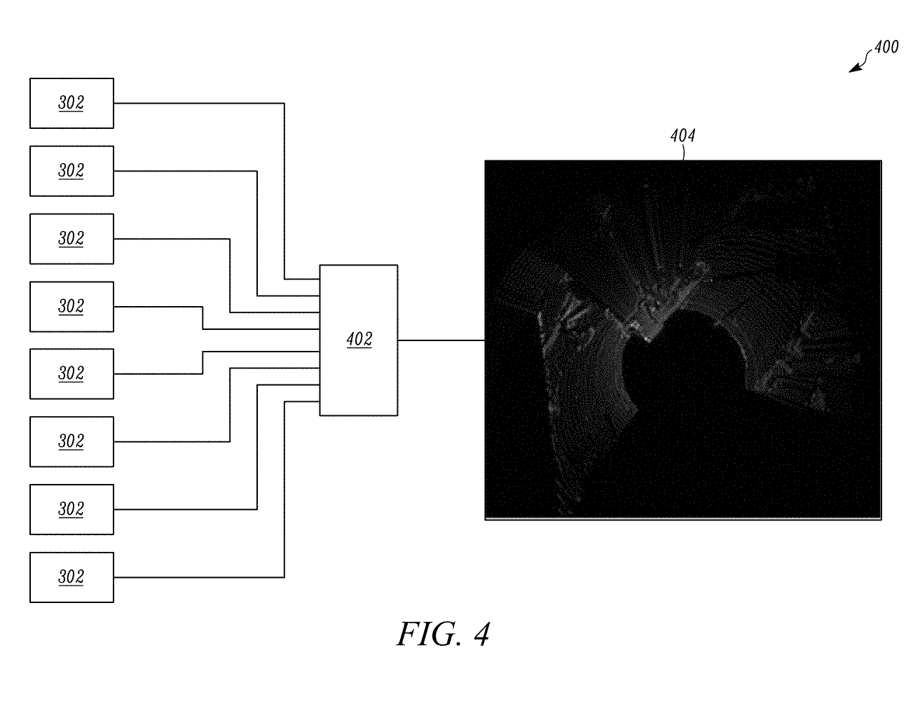

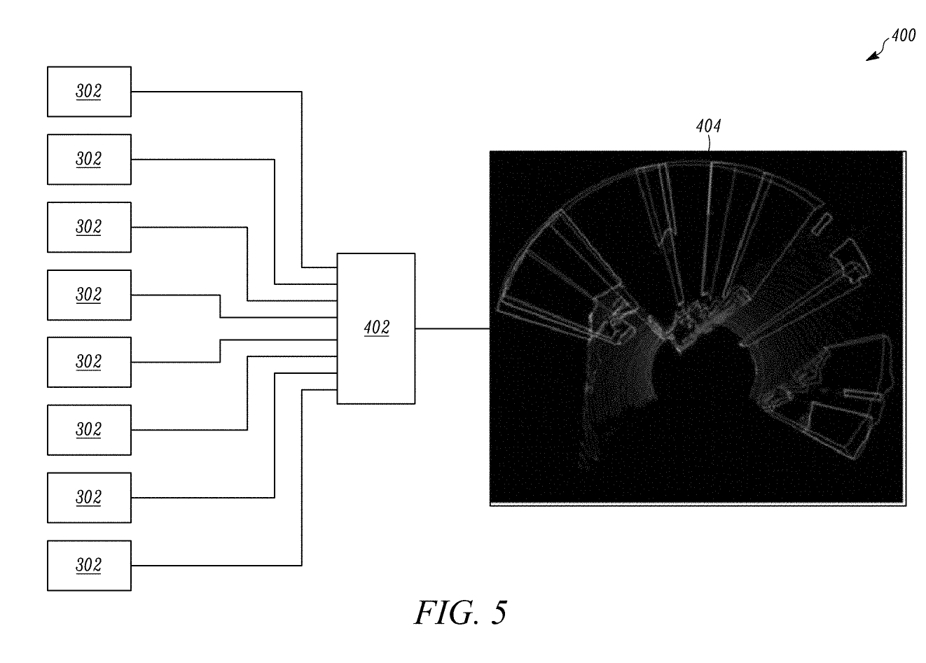

Referring to FIG. 3, a perception system 300 may be mounted on or associated with the machine 102. The perception system 300 may include one or more systems such as a Light Detection And Ranging (LADAR) system, a radar system, a Sound Navigation And Ranging (SONAR) system, and/or any other desired system that operate with associated with one or more perception sensors 302. The perception sensors 302 may generate data points that are received by a processing device 402 (see FIGS. 4 and 5) and used by the processing device 402 to determine the position of the work surface 101 and the presence and position of obstacles within the range of the perception sensors 302. The field of view of each of the perception sensors 302 is depicted schematically in FIG. 3 by reference number 304.

The perception system 300 may include a plurality of perception sensors 302 mounted on the machine 102 for generating perception data from a plurality of points of view relative to the machine 102. Each of the perception sensor 302 may be mounted on the machine 102 at a relatively high vantage point. As depicted schematically in FIG. 3, eight perception sensors 302 are provided that record or sense images in the forward and rearward directions as well as to each side of the machine 102. The perception sensor 302 may be positioned in other locations as desired. The number and location of the perception sensors 302 described herein is exemplary and does not limit the scope of the present disclosure.

The present disclosure relates to an environment recognition system 400 (see FIGS. 4 and 5) associated with the machines 102 operating at the worksite 100. The environment recognition system 400 includes the processing device 402. Referring to FIGS. 4 and 5, the processing device 402 is communicably coupled to the perception sensors 302. The processing device 402 may receive the data points from the perception sensors 402 and generate point cloud data associated with the worksite 100. In some embodiments, the processing device 402 may combine the raw data points captured by the perception sensors 302 into a unified environment map 404 of at least a portion of the worksite 100 adjacent and surrounding the machine 102. The generated environment map 404 may represent all the point cloud data available for the environment adjacent machine 102.

In one example, the generated environment map 404 represents a 360-degree view or model of the environment of the machine 102, with the machine 102 at the center of the 360-degree view. According to some embodiments, the generated environment map 404 may be a non-rectangular shape. For example, the generated environment map 404 may be hemispherical and the machine 102 may be conceptually located at the pole, and in the interior, of the hemisphere. The generated environment map 404 shown in the accompanying figures is exemplary and does not limit the scope of the present disclosure.

The processing device 402 may generate environment map 404 by mapping raw data points captured by the perception sensors 302 to an electronic or data map. The mapping may correlate a two dimensional point from a perception sensor 302 to a three dimensional point on the generated environment map 404. For example, a raw data point of the data point located at (1, 1) may be mapped to location (500, 500, 1) of the generated environment map 404. The mapping may be accomplished using a look-up table that may be stored within the processing device 402. The look-up table may be configured based on the position and orientation of each of the perception sensors 302 on the machine 102. Alternatively, other methods for transforming the data points from the perception sensors 302 into the point cloud data may be utilized without any limitation.

The processing device 402 is configured to detect a plurality of objects (see FIG. 5) within the generated environment map 404. The processing device 402 may utilize any known object segmentation technique to detect the objects within the generated environment map 404. In one embodiment, the environment recognition system 400 may also include an object identification system (not system). The object identification system may operate to differentiate and store within the generated environment map 404 categories of objects detected such as machines, light duty vehicles, personnel, or fixed objects.

In some instances, the object identification system may operate to further identify and store the specific object or type of object detected. The object identification system may be any type of system that determines the type of object that is detected. In one embodiment, the object identification system may embody a computer based system that uses edge detection technology to identify the edges of the detected object and then matches the detected edges with known edges contained within a data map or database to identify the object detected. Other types of object identification systems and methods of object identification are contemplated. Further, the processing device 402 is configured to extract a geometry of the objects based on the detection. This extracted geometry may be indicative of an estimated geometry of the object.

Based on the extracted geometry of the object, the processing device 402 may compute an expected shadow that the object should cast on the generated environment map 404. Further, the processing device 402 may compute a polyhedron indicative of a region on the generated environment map 404 that the respective object may occlude. In one embodiment, the polyhedron may be computed using ray tracing technique. In order to compute the polyhedron, the processing device 402 may consider the position and orientation of the perception sensor 302 and the geometry of the rays coming from it. The rays that fall on the boundary of the object form points on the polyhedron at their intersection point on the object, and form edges of the polyhedron as they continue beyond the object. In one embodiment, the expected shadow of the object may be computed by projecting a front face of the object onto a detected ground surface following these rays.

In addition, the generated environment map 404 corresponding to the environment around the machine 102 may include missing data points. The processing device 402 is configured to detect the one or more missing data points within the generated environment map 404. These missing data points are indicative of holes in the point cloud data. Further, the missing data points represent a casted shadow of the respective object within the generated environment map 404.

A person of ordinary skill in the art will appreciate that the missing data points are blind zones or areas of limited information or visibility. For example, in some instances, the fields of some or all of the perception sensors 302 may be limited so as not to cover or extend fully about the machine 102 or only extend a limited distance in one or more directions. This may be due to limitations in the range or capabilities of the perception sensors 302, the software associated with the perception sensors 302, and/or the positioning of the perception sensors 302. Such limitations of the perception sensors 302 are typically known to the processing device 402. Further, the processing device 402 is able to determine an amount of the missing data points caused by such limitations of the perception sensors 302 and an amount of the missing data points caused by object occlusion. The processing device 402 computes a geometry of the casted shadow of the respective objects.

The processing device 402 is further configured to compare the expected shadow with the casted shadow of the respective object. If the expected shadow matches the casted shadow of the respective object, the processing device 402 determines that a true geometry of the respective object is same as that of the extracted geometry of the object obtained from the environment map 404. However, if the expected shadow does not match the casted shadow of the respective object, the processing device 402 determines that the true geometry of the respective object is different from the extracted or estimated geometry. Moreover, if there is a mismatch between the expected shadow and the casted shadow, the processing device 402 determines that the geometry of the object has been misestimated. Misestimating the geometry of the object may be indicative of incorrect estimation of at least one dimension of the object. In one embodiment, the mismatch between the expected shadow and the casted shadow of the object may be indicative that the processing device 402 underestimated the geometry of the object.

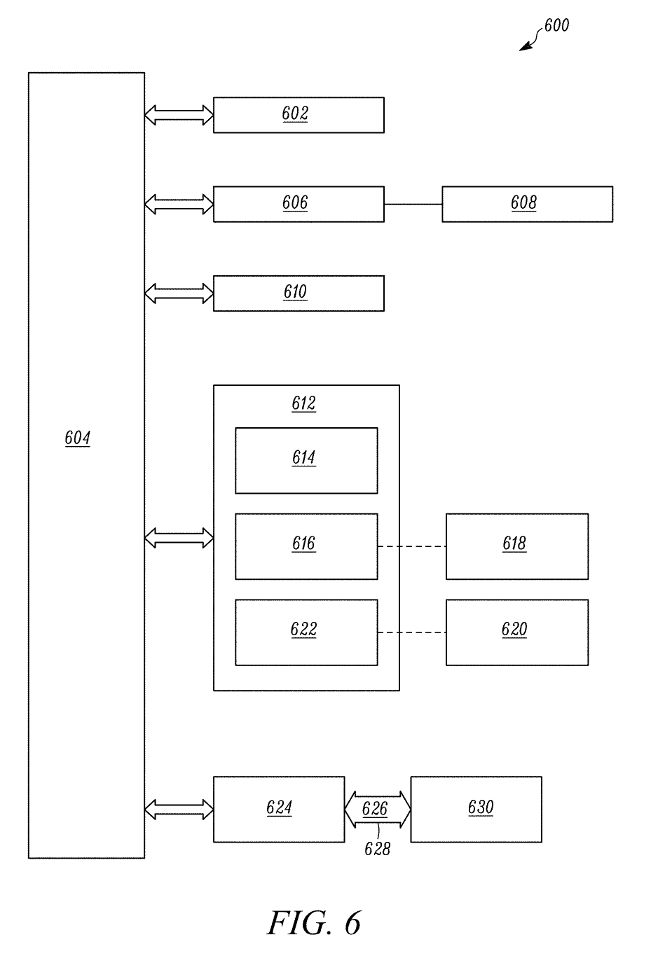

FIG. 6 is an exemplary low-level implementation of the environment recognition system 400 of FIGS. 4 and 5. The present disclosure has been described herein in terms of functional block components, modules, and various processing steps. It should be appreciated that such functional blocks may be realized by any number of hardware and/or software components configured to perform the specified functions. For example, a computer based system, hereinafter referred as system 600 may employ various integrated circuit components, e.g., memory elements, processing elements, logic elements, look-up tables, and/or the like, which may carry out a variety of functions under the control of one or more microprocessors or other control devices. Similarly, the software elements of the system 600 may be implemented with any programming or scripting language such as, but not limited to, C, C++, Java, COBOL, assembler, PERL, Visual Basic, SQL Stored Procedures, extensible markup language (XML), with the various algorithms being implemented with any combination of data structures, objects, processes, routines or other programming elements.

Further, it should be noted that the system 600 may employ any number of conventional techniques for data transmission, signaling, data processing, network control, and/or the like. Still further, the system 600 could be configured to detect or prevent security issues with a user-side scripting language, such as JavaScript, VBScript or the like. In an embodiment of the present disclosure, the networking architecture between components of the system 600 may be implemented by way of a client-server architecture. In an additional embodiment of this disclosure, the client-server architecture may be built on a customizable.Net (dot-Net) platform. However, it may be apparent to a person ordinarily skilled in the art that various other software frameworks may be utilized to build the client-server architecture between components of the system 600 without departing from the spirit and scope of the disclosure.

These software elements may be loaded onto a general purpose computer, special purpose computer, or other programmable data processing apparatus to produce a machine, such that the instructions that execute on the computer or other programmable data processing apparatus create means for implementing the functions disclosed herein. These computer program instructions may also be stored in a computer-readable memory that can direct a computer or other programmable data processing apparatus to function in a particular manner, such that the instructions stored in the computer-readable memory produce instructions which implement the functions disclosed herein. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions disclosed herein.

The present disclosure (i.e., system 400, system 600, method 700, any part(s) or function(s) thereof) may be implemented using hardware, software or a combination thereof, and may be implemented in one or more computer systems or other processing systems. However, the manipulations performed by the present disclosure were often referred to in terms such as detecting, determining, and the like, which are commonly associated with mental operations performed by a human operator. No such capability of a human operator is necessary, or desirable in most cases, in any of the operations described herein, which form a part of the present disclosure. Rather, the operations are machine operations. Useful machines for performing the operations in the present disclosure may include general-purpose digital computers or similar devices. In accordance with an embodiment of the present disclosure, the present disclosure is directed towards one or more computer systems capable of carrying out the functionality described herein. An example of the computer based system includes the system 600, which is shown by way of a block diagram in FIG. 6.

The system 600 includes at least one processor, such as a processor 602. The processor 602 may be connected to a communication infrastructure 604, for example, a communications bus, a cross-over bar, a network, and the like. Various software embodiments are described in terms of this exemplary system 600. Upon perusal of the present description, it will become apparent to a person skilled in the relevant art(s) how to implement the present disclosure using other computer systems and/or architectures. The system 600 includes a display interface 606 that forwards graphics, text, and other data from the communication infrastructure 604 for display on a display unit 608.

The system 600 further includes a main memory 610, such as random access memory (RAM), and may also include a secondary memory 612. The secondary memory 612 may further include, for example, a hard disk drive 614 and/or a removable storage drive 616, representing a floppy disk drive, a magnetic tape drive, an optical disk drive, etc. Removable storage drive 616 reads from and/or writes to a removable storage unit 618 in a well-known manner. The removable storage unit 618 may represent a floppy disk, magnetic tape or an optical disk, and may be read by and written to by the removable storage drive 616. As will be appreciated, the removable storage unit 618 includes a computer usable storage medium having stored therein, computer software and/or data.

In accordance with various embodiments of the present disclosure, the secondary memory 612 may include other similar devices for allowing computer programs or other instructions to be loaded into the system 600. Such devices may include, for example, a removable storage unit 620, and an interface 622. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit 620 to system 600.

The system 600 may further include a communication interface 624. The communication interface 624 allows software and data to be transferred between the system 600 and external devices 630. Examples of the communication interface 624 include, but may not be limited to a modem, a network interface (such as an Ethernet card), a communications port, a Personal Computer Memory Card International Association (PCMCIA) slot and card, and the like. Software and data transferred via the communication interface 624 may be in the form of a plurality of signals, hereinafter referred to as signals 626, which may be electronic, electromagnetic, optical or other signals capable of being received by the communication interface 624. The signals 626 may be provided to the communication interface 624 via a communication path (e.g., channel) 628. The communication path 628 carries the signals 626 and may be implemented using wire or cable, fiber optics, a telephone line, a cellular link, a radio frequency (RF) link and other communication channels.

In this document, the terms “computer program medium” and “computer usable medium” are used to generally refer to media such as the removable storage drive 616, a hard disk installed in the hard disk drive 614, the signals 626, and the like. These computer program products provide software to the system 600. The present disclosure is also directed to such computer program products.

The computer programs (also referred to as computer control logic) may be stored in the main memory 610 and/or the secondary memory 612. The computer programs may also be received via the communication interface 604. Such computer programs, when executed, enable the system 600 to perform the functions consistent with the present disclosure, as discussed herein. In particular, the computer programs, when executed, enable the processor 602 to perform the features of the present disclosure. Accordingly, such computer programs represent controllers of the system 600.

In accordance with an embodiment of the present disclosure, where the disclosure is implemented using a software, the software may be stored in a computer program product and loaded into the system 600 using the removable storage drive 616, the hard disk drive 614 or the communication interface 624. The control logic (software), when executed by the processor 602, causes the processor 602 to perform the functions of the present disclosure as described herein.

In another embodiment, the present disclosure is implemented primarily in hardware using, for example, hardware components such as application specific integrated circuits (ASIC). Implementation of the hardware state machine so as to perform the functions described herein will be apparent to persons skilled in the relevant art(s). In yet another embodiment, the present disclosure is implemented using a combination of both the hardware and the software.

Various embodiments disclosed herein are to be taken in the illustrative and explanatory sense, and should in no way be construed as limiting of the present disclosure. All numerical terms, such as, but not limited to, “first”, “second”, “third”, or any other ordinary and/or numerical terms, should also be taken only as identifiers, to assist the reader's understanding of the various embodiments, variations, components, and/or modifications of the present disclosure, and may not create any limitations, particularly as to the order, or preference, of any embodiment, variation, component and/or modification relative to, or over, another embodiment, variation, component and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

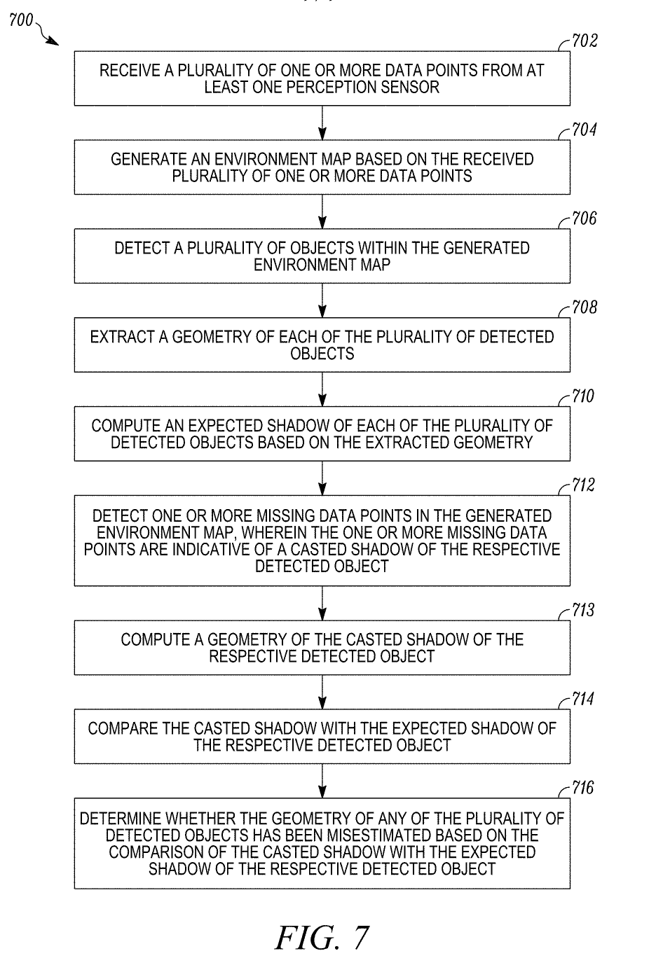

The present disclosure relates to the system and method for environment recognition associated with the worksite 100. FIG. 7 is a flowchart of the method 700 of operation of the environment recognition system 400. At step 702, the processing device 402 of the environment recognition system 400 receives the one or more data points from the perception sensors 302. At step 704, the processing device 402 generates the environment map 404 based on the received data points. At step 706, the processing device 402 detects the objects within the generated environment map 404. At step 708, the processing device 402 extracts the geometry of the detected objects. At step 710, the processing device 402 computes the expected shadow of the detected objects based on the extracted geometry. At step 712, the processing device 402 detects one or more missing data points in the generated environment map 404. The one or more missing data points are indicative of the casted shadow of the respective detected object. At step 713, the processing device 402 computes a geometry of the casted shadow of the respective detected object. At step 714, the processing device 402 compares the casted shadow with the expected shadow of the respective detected object. At step 716, the processing device 402 determines whether the geometry of any of the plurality of detected objects has been misestimated based on the comparison of the casted shadow with the expected shadow of the respective detected object.

The environment recognition system 400 is capable of determining if the missing data in the environment map 404 are due to object occlusion, obscurant (dust/rain) occlusions or sensor blockage. The processing device 402 extracts the shape of the object causing the occlusion based on the casted shadow within the generated map 404. Further, the processing device 402 may judge whether the dimensions of the object have been misestimated. Further, by using already available information about sensor limitations, the processing device 402 may determine what percent of the mismatch is due to occlusion rather than sensor limitations. This may help to minimize the impacts of sensor resolution, viewpoint limitations, and environmental constraints.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

What is claimed is:

1. An environment recognition system for a machine operating at a worksite, the environment recognition system comprising:
at least one perception sensor associated with the machine, the at least one perception sensor configured to output a plurality of data points corresponding to an environment around the machine; and
a processing device communicably coupled to the at least one perception sensor, the processing device configured to:
receive the plurality of data points from the at least one perception sensor;
generate an environment map based on the received plurality of data points;
detect a plurality of objects within the generated environment map;
extract a geometry of each of the plurality of detected objects;
compute an expected shadow of each of the plurality of detected objects based on the extracted geometry;
detect one or more missing data points in the generated environment map, the one or more missing data points being indicative of a casted shadow of the respective detected object;
compute a geometry of the casted shadow of the respective detected object;
compare the casted shadow with the expected shadow of the respective detected object; and
determine whether the geometry of any of the plurality of detected objects has been misestimated based on the comparison of the casted shadow with the expected shadow of the respective detected object.

2. The environment recognition system of claim 1, wherein the at least one perception sensor includes a Light Detection And Ranging (LADAR) sensor.

3. The environment recognition system of claim 1, wherein the one or more missing data points are indicative of holes in a point cloud of the generated environment map.

4. The environment recognition system of claim 1, wherein the processing device is configured to compute the expected shadow by computing a polyhedron representing a region on the generated environment map that the respective detected object occludes.

5. The environment recognition system of claim 4, wherein the processing device is configured to compute the expected shadow using ray tracing technique.

6. The environment recognition system of claim 1, wherein the processing device is further configured to estimate a true geometry of the plurality of detected objects based, at least in part, on the one or more missing data points in the generated environment map.

7. The environment recognition system of claim 1, wherein the processing device is further configured to determine an amount of the mismatch between the casted shadow and the expected shadow of the respective detected object caused by sensor limitations based, at least in part, on a predetermined range associated with the respective at least one perception sensor.

8. The environment recognition system of claim 1, wherein the processing device is configured to detect the plurality of objects using object segmentation technique.

9. A method for environment recognition associated with a machine operating on a worksite, the method comprising:
receiving a plurality of one or more data points from at least one perception sensor;
generating an environment map based on the received plurality of one or more data points;
detecting a plurality of objects within the generated environment map;
extracting a geometry of each of the plurality of detected objects;
computing an expected shadow of each of the plurality of detected objects based on the extracted geometry;
detecting one or more missing data points in the generated environment map, the one or more missing data points being indicative of a casted shadow of the respective detected object;
computing a geometry of the casted shadow of the respective detected object;
comparing the casted shadow with the expected shadow of the respective detected object; and
determining whether the geometry of any of the plurality of detected objects has been misestimated based on the comparison of the casted shadow with the expected shadow of the respective detected object.

10. The method of claim 9, wherein the one or more missing data points are indicative of holes in a point cloud of the generated environment map.

11. The method of claim 9, wherein the expected shadow by is computed by computing a polyhedron representing a region on the generated environment map that the respective detected object occludes.

12. The method of claim 11, wherein the expected shadow is computed using ray tracing technique.

13. The method of claim 9 further comprising estimating a true geometry of the plurality of detected objects based, at least in part, on the one or more missing data points in the generated environment map.

14. The method of claim 9 further comprising determining an amount of the mismatch between the casted shadow and the expected shadow of the respective detected object caused by sensor limitations based, at least in part, on a predetermined range associated with the respective at least one perception sensor.

15. The method of claim 1, wherein the plurality of objects are detected using object segmentation technique.

16. A computer program product embodied in a computer readable medium, the computer program product being useable with a programmable processing device for environment recognition at a worksite, the computer program product configured to execute a set of instructions comprising:
receiving a plurality of one or more data points from at least one perception sensor;
generating an environment map based on the received plurality of one or more data points;
detecting a plurality of objects within the generated environment map;
extracting a geometry of each of the plurality of detected objects;
computing an expected shadow of each of the plurality of detected objects based on the extracted geometry;
detecting one or more missing data points in the generated environment map, the one or more missing data points being indicative of a casted shadow of the respective detected object;
computing a geometry of the casted shadow of the respective detected object;
comparing the casted shadow with the expected shadow of the respective detected object; and
determining whether the geometry of any of the plurality of detected objects has been misestimated based on the comparison of the casted shadow with the expected shadow of the respective detected object.

17. The computer program product of claim 16 further configured to execute a set of instructions comprising estimating a true geometry of the plurality of detected objects based, at least in part, on the one or more missing data points in the generated environment map.

18. The computer program product of claim 16 further configured to execute a set of instructions comprising determining an amount of the mismatch between the casted shadow and the expected shadow of the respective detected object caused by sensor limitations based, at least in part, on a predetermined range associated with the respective at least one perception sensor.

19. The computer program product of claim 16, wherein the plurality of objects are detected using object segmentation technique.

20. The computer program product of claim 16, wherein the one or more missing data points are indicative of holes in a point cloud of the generated environment map.
